(19) United States
(12) Patent Application Publication
(10) Pub. No.: US 2007/0231471 A1
(43) Pub. Date: Oct. 4, 2007

(54) Method for manufacturing magnetic recording medium

(75) Inventors: Katsuhiko Yamazaki, Tokyo (JP); Tsutomu Ide, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/727,326

(22) Filed: Mar. 26, 2007

(30) Foreign Application Priority Data
Mar. 28, 2006 (JP) 2006-89444

(51) Int. Cl. B05D 5/12

(52) U.S. Cl. 427/127

(57) ABSTRACT

A method for manufacturing a magnetic recording medium is provided which has high recording density and which is less likely to cause problems of a magnetic tape such as inappropriate contact with a head, unstable running, and damage. A back-coat layer containing plate-like inorganic pigment (plate-like inorganic pigment-containing layer) is formed over a non-magnetic support to produce an intermediate product having the support and the back-coat layer. Then, the intermediate product is subjected to calendering between at least one pair of metal rolls.

### BACKGROUND OF THE INVENTION

1. Field of the Invention

The present invention relates to a method for manufacturing a magnetic recording medium provided with a magnetic tape.

2. Description of the Related Art

Conventionally, magnetic recording media provided with a magnetic tape and referred to as, for example, LTO (Linear Tape Open, a registered trademark) or DLT (Digital Linear Tape, a registered trademark) have improved recording density which has been achieved by the finer magnetic particles constituting a magnetic layer, the thinned magnetic tape, or other means. Also, further improvement in the recording density is desired in the future.

Meanwhile, as the thickness of a magnetic tape decreases, the stiffness and the mechanical strength deteriorate, thereby likely causing problems such as inappropriate contact with a head, unstable running, and damage on the surface of the tape.

In view of the above, a method is known in which plate-like inorganic pigment such as plate-like iron oxide is mixed into a back-coat layer, an underlayer, or an intermediate layer to thereby improve the stiffness and the mechanical strength of a magnetic tape (see, for example, Japanese Patent Laid-Open Publications Nos. 2004-39086 and 2004-253069).

However, even when plate-like inorganic pigment is mixed into a back-coat layer, an underlayer, or an intermediate layer as mentioned above, the problems such as inappropriate contact with a head, unstable running, and damage on the surface of a tape are not always sufficiently suppressed.

### SUMMARY OF THE INVENTION

In view of the foregoing problems, various exemplary embodiments of this invention provide a method for manufacturing a magnetic recording medium which has high recording density and which is less likely to cause problems of a magnetic tape, such as inappropriate contact with a head, unstable running, and damage on the surface of the tape.

Various exemplary embodiments of the present invention achieve the aforementioned object by forming a plate-like inorganic pigment-containing layer containing plate-like inorganic pigment over a non-magnetic support to produce an intermediate product having the support and the plate-like inorganic pigment-containing layer, and subjecting the intermediate product to calendering between at least one pair of metal rolls.

In the course of arriving at the present invention, the present inventors have conducted intensive studies on the reasons why the problems such as inappropriate contact with a head, unstable running, and damage on the surface of a tape cannot be satisfactorily suppressed even when plate-like inorganic pigment such as plate-like iron oxide is mixed into a back-coat layer, an underlayer, or an intermediate layer. Consequently, the inventors have found that the mixing of the plate-like inorganic pigment results in an increased surface roughness of the magnetic tape, thereby giving rise to a new cause of inappropriate contact with a head, unstable running, damage on the surface of the tape, and the like.

For example, when plate-like inorganic pigment such as plate-like iron oxide is mixed into an underlayer, the surface roughness of the underlayer increases. A magnetic layer is formed by applying a magnetic layer paint over the underlayer, and the surface shape of the underlayer is reflected in the surface of the magnetic layer. Therefore, when the surface roughness of the underlayer is large, the surface roughness of the magnetic layer becomes large. This may cause inappropriate contact with a head and unstable running.

Furthermore, when plate-like inorganic pigment such as plate-like iron oxide is mixed into a back-coat layer, the surface roughness of the back-coat layer increases. Since a magnetic tape is wound on a reel such that a magnetic layer overlies the previous winding of the back-coat layer, the surface shape of the back-coat layer is transferred to the surface of the magnetic layer to some extent. Therefore, also in this case, the surface roughness of the magnetic layer increases, causing inappropriate contact with a head and unstable running in some cases.

Moreover, when the magnetic tape is wound on the reel or is unwound from the reel, the back-coat layer having large surface roughness is rubbed with the magnetic layer, causing damage on the surface of the magnetic layer in some cases.

Carbon is sometimes mixed into a back-coat layer in order to reduce the electrical resistance to prevent electrification. However, particularly in a back-coat layer containing plate-like inorganic pigment and carbon together, the surface roughness thereof is more likely to become large, and thus the problems such as inappropriate contact with a head, unstable running, and damage on the surface of the magnetic layer are more likely to occur.

In view of the above points, the present inventors have subjected an intermediate product having a support and a plate-like inorganic pigment-containing layer to calendering between at least one pair of metal rolls to thereby reduce the surface roughness of the plate-like inorganic pigment-containing layer. Consequently, the inventors have found that the problems of a magnetic tape due to the newly identified cause, i.e., the large surface roughness of the plate-like inorganic pigment-containing layer, can be solved by the calendering process. In particular, the inventors have found that the effect of suppressing surface roughness is significantly high for a back-coat layer (a plate-like inorganic pigment-containing layer) containing plate-like inorganic pigment and carbon together.

As described above, the present inventors have found the cause of the problems of a magnetic tape when plate-like inorganic pigment is mixed into an underlayer, a back-coat layer, or an intermediate layer, and have solved the problems of a magnetic tape due to the newly identified cause by subjecting an intermediate product having a plate-like inorganic pigment-containing layer to calendering between at least one pair of metal rolls. Thus, the invention has been made based on a concept different from that in the conventional technology.

Accordingly, various exemplary embodiments of this invention provide a method for manufacturing a magnetic recording medium, comprising: a plate-like inorganic pigment-containing layer forming step of forming a plate-like inorganic pigment-containing layer containing plate-like inorganic pigment over a non-magnetic support to produce an intermediate product having the support and the plate-like inorganic pigment-containing layer; and a calendaring step of calendering the intermediate product between at least one pair of metal rolls, wherein the steps are carried out sequentially in this order.

It should be noted that the term “plate-like inorganic pigment” used herein refers to plate-like inorganic powder such as α-iron oxide, barium sulfate, titanium oxide, zinc oxide, mica, and kaolin. Preferably, the ratio of plate diameter to thickness of the plate-like inorganic pigment is 5 or more.

In various exemplary embodiments of the present invention, an intermediate product having a support and a plate-like inorganic pigment-containing layer is subjected to calendering between at least one pair of metal rolls to thereby reduce the surface roughness of the plate-like inorganic pigment-containing layer. In this manner, a magnetic recording medium can be manufactured which has high recording density and which is less likely to cause problems such as inappropriate contact with a head, unstable running, and damage on the surface of a tape.

### BRIEF DESCRIPTION OF THE DRAWINGS

FIG. 1 is a side cross-sectional view schematically illustrating a step of forming a back-coat layer of a magnetic tape according to one exemplary embodiment of the present invention;

FIG. 2 is a side cross-sectional view schematically illustrating a step of calendering the magnetic tape; and

FIG. 3 is a flowchart showing the outline of a method for manufacturing the magnetic tape.

### DETAILED DESCRIPTION OF THE PREFERRED EMBODIMENTS

Preferred exemplary embodiments of the present invention will be described in detail below with reference to the drawings.

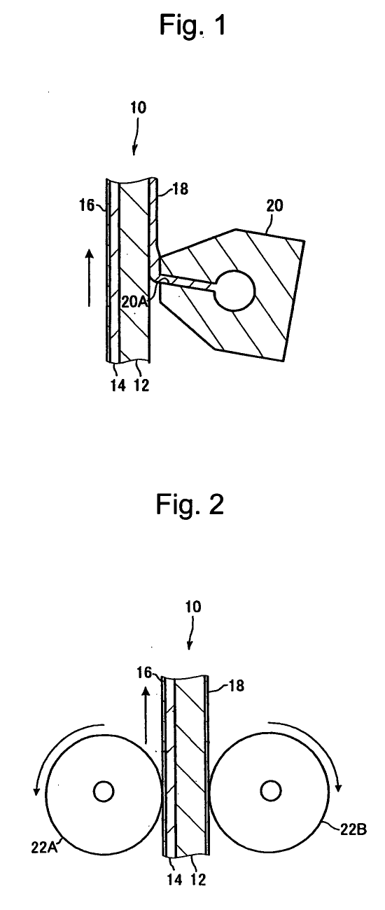

The present exemplary embodiment relates to a method for manufacturing a magnetic tape constituting a magnetic recording medium. The method is characterized by the steps of forming a back-coat layer (a plate-like inorganic pigment-containing layer) 18 containing plate-like inorganic pigment over a non-magnetic support 12, as shown in FIG. 1, to produce an intermediate product 10 having the support 12 and the back-coat layer 18; and subjecting the intermediate product 10 to calendering between a pair of metal rolls 22A and 22B, as shown in FIG. 2. A description of the other steps is omitted as appropriate since the other steps are not considered to be important for understanding the present exemplary embodiment.

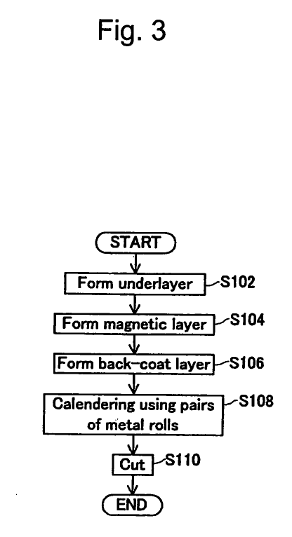

A description will now be given of the magnetic tape manufacturing method according to the present exemplary embodiment with reference to the flowchart shown in FIG. 3.

First, while the support 12 is being fed in its longitudinal direction, an underlayer paint is ejected from a nozzle (not shown) disposed close to the surface of the support 12 and is applied to the support 12. Then, the underlayer paint is dried to form an underlayer 14 (S102).

Examples of the material for the support 12 include: polyester resins such as polyethylene terephthalate and polyethylene naphthalate; polyolefin resins such as polypropylene; and resin materials such as polyamide, polyimide, polyamide-imide, polysulfone cellulose triacetate, and polycarbonate.

The underlayer paint is prepared by dispersing a non-magnetic powder and a binder in a solvent. Further, a dispersant, an abrasive, a lubricant, and the like may be added as required. Examples of the non-magnetic powder include: carbon blacks such as furnace black for rubber, thermal black for rubber, black for color, and acetylene black; inorganic powders such as α-iron oxide, titanium oxide, calcium carbonate, α-alumina, chromium oxide, barium sulfate, silicon carbide, and silicon oxide; and mixtures thereof. In this instance, the shape of the non-magnetic powder may be any of a spherical shape, a needle-like shape, a spindle-like shape, and a plate-like shape. However, a spherical shape or a needle-like shape is preferred.

Examples of the binder include: thermoplastic resins such as vinyl chloride-based copolymers, polyurethane-based resins, acrylic resin, polyester-based resin, acrylonitrile-butadiene-based copolymer, polyamide-based resin, polyvinyl butyral-based resin, nitrocellulose, styrene-butadiene-based copolymers, polyvinyl alcohol resin, acetal resin, epoxy-based resin, phenoxy-based resin, polyether resin, polyimide resin, phenolic resin, a polybutadiene elastomer, and synthetic rubber-based resin; thermosetting resins such as condensation-polymerizable phenolic resin, epoxy resin, polyurethane curable resins, urea resin, butyral resin, polymar (Registered Trade Mark) resin, melanin resin, alkyd resin, silicone resin, acrylic-based reactive resin, polyamide resin, epoxy-polyamide resin, saturated polyester resin, and urea formaldehyde resins; radiation curable resins; and mixtures thereof.

Examples of the dispersant include various surfactants. Examples of the abrasive include α-alumina, chromium oxide, silicon carbide, silicon oxide, aluminum nitride, and boron nitride. Furthermore, examples of the lubricant include higher fatty acid, fatty acid ester, and silicone oil.

In terms of reducing the total thickness of a magnetic tape in order to increase a storage capacity per one cartridge, it is desirable to reduce the thickness of the underlayer 14. On the other hand, in order to sufficiently reduce the surface roughness of the underlayer 14 irrespective of the degree of the surface roughness of the support 12 and in order to store a sufficient amount of the lubricant, to be supplied to a magnetic layer, in the underlayer, it is desirable that the thickness of the underlayer 14 be a certain value or more. Specifically, the thickness of the underlayer 14 is preferably 0.3 μm to 1.2 μm.

Next, while the support 12 is being fed in its longitudinal direction, a magnetic layer paint is ejected from a nozzle (not shown) disposed close to the surface of the underlayer 14 and is applied to the underlayer 14. Then, the paint is dried to form the magnetic layer 16 (S104). In the present exemplary embodiment, the magnetic layer paint is applied to the dried underlayer 14. Namely, the magnetic layer paint is applied by means of a wet-on-dry application method.

The magnetic layer paint is prepared by dispersing a ferromagnetic powder and a binder in a solvent. Further, a dispersant, an abrasive, a lubricant, and the like may be added as required.

Examples of the magnetic powder include: ferromagnetic oxide powders such as γ-Fe₂O₃, Fe₃O₄, a solid solution of γ-Fe₂O₃ and Fe₃O₄, Co compound-coated γ-Fe₂O₃, Co compound-doped γ-Fe₂O₃, Co compound-coated Fe₃O₄, Co compound-doped Fe₃O₄, a solid solution of Co compound-coated γ-Fe₂O₃ and Co compound-coated Fe₃O₄, a solid solution of Co compound-doped γ-Fe₂O₃ and Co compound-doped Fe₃O₄, and CrO₂, an Fe—Co—Ni alloy, an Fe—Al alloy, a Mn—Bi alloy, an Fe—Al—P alloy, an Fe—Co—Ni—Cr alloy, an Fe—Ni—Zn alloy, an Fe—Co—Ni—P alloy, an Fe—Ni alloy, a Co—Ni alloy, a Co—P alloy, an Fe—Mn—Zn alloy, and an Fe—Ni—Cr—P alloy, ferromagnetic powder containing Fe, Ni, and Co as main components. In this instance, the shape of the magnetic powder is preferably a needle shape.

Examples of the binder for use in the magnetic layer 16 include the same thermoplastic resins, thermosetting resins, and radiation curable resins, and mixtures thereof as those for the binder of the above-described underlayer paint.

Furthermore, the same dispersant, abrasive, and lubricant as those for the abovementioned underlayer paint may be used as the dispersant, the abrasive, and the lubricant for the magnetic layer 16.

Examples of the solvent for use in the magnetic layer paint include cyclohexanone, methyl ethyl ketone, methyl isobutyl ketone, methyl n-butyl ketone, ethyl n-butyl ketone, diisobutyl ketone, isophorone, methyl cellosolve, ethyl cellosolve, toluene, ethyl acetate, and tetrahydrofuran.

The magnetic layer paint is dried by heating the paint in a drying furnace (not shown) by means of hot air, far infrared rays, an electric heater, or the like to volatilize the solvent components. At this time, a magnetic field is applied to the magnetic layer paint applied to the underlayer 14 by means of a permanent magnet, an electromagnet, or the like to align the magnetic particles in the magnetic layer paint along the feeding direction of the support 12. Alternatively, a magnetic field may be applied to the magnetic layer paint at a point between the application of the magnetic layer paint and the drying of the magnetic layer paint to thereby align the magnetic particles in the magnetic layer paint along the feeding direction of the support 12.

Next, while the support 12 is being fed in its longitudinal direction, a back-coat layer paint is ejected from a nozzle 20 disposed close to a surface of the support 12 which surface is opposite to the other one having the magnetic layer 16, and is applied to the support 12. Then, the paint is dried to form the back-coat layer 18 (S106).

The back-coat layer paint is prepared by dispersing plate-like inorganic pigment, carbon black, and a binder in a solvent. Furthermore, a dispersant, an abrasive, a lubricant, and the like may be added in accordance with need.

Examples of the plate-like inorganic pigment include inorganic powders such as α-Fe₂O₃, TiO₂, ZnO, various types of mica, Al₂O₃-2SiO₂-2H₂O (kaolin). Further, the same carbon black, binder, dispersant, abrasive, and lubricant as those for the underlayer 14 above may be used for those for the back-coat layer paint.

The nozzle 20 has a slit 20A formed at the end thereof so that the back-coat layer paint is ejected from the slit 20A. The support 12 is fed in its longitudinal direction with a predetermined tension applied thereto, and the nozzle 20 is disposed such that the end thereof is pressed against the surface of the support 12. Further, the nozzle 20 is disposed such that the back-coat layer paint is ejected in a direction slightly inclined, with respect to a direction perpendicular to the surface of the support 12, to the feeding direction of the support 12. Since the ejected back-coat layer paint intervenes between the nozzle 20 and the support 12, the end of the nozzle 20 is brought into proximity to the surface of the support 12 without contacting the support 12.

Subsequently, the intermediate product 10 having the support 12, the underlayer 14, the magnetic layer 16, and the back-coat layer 18 is subjected to calendering between the pair of metal rolls 22A and 22B (S108). Rolls formed by subjecting rolls of steel such as STKM (carbon steel tubes for machine structural purposes), SCM (chromium molybdenum steel), or SUJ (high carbon chromium bearing steel) to hard chromium plating or ceramic coating may be used as the metal rolls 22A and 22B. Alternatively, rolls made of a superalloy may be used as the metal rolls 22A and 22B.

The processing temperature of the calendering is preferably 70 to 110° C., and more preferably 90 to 110° C. The linear pressure between the metal rolls 22A and 22B is preferably 1.9×10⁵ to 3.8×10⁵ N/m, and more preferably 2.4×10⁵ to 3.8×10⁵N/m. The diameter of the metal rolls 22A and 22B is preferably 50 to 500 mm. The feeding speed of the intermediate product 10 during calendering is preferably 20 to 900 m/min. The number of nips is preferably 2 to 8, and more preferably 4 to 6. Therefore, preferably, the calendering is performed by means of a calendering apparatus provided with two to eight pairs of the metal rolls 22A and 22B. More preferably, the calendering is performed by means of a calendering apparatus provided with four to six pairs of the metal rolls 22A and 22B.

Next, the support 12 having the magnetic layer 16 and the underlayer 14 formed thereon is cut to a predetermined width (S110) In this manner, the magnetic tape is complete.

The thus obtained magnetic tape is wound on a reel (not shown), and the reel is mounted within a cartridge (not shown). Hence, a magnetic recording medium is complete.

In the present exemplary embodiment, the back-coat layer forming step (S106) is carried out after the magnetic layer forming step (S104). However, the back-coat layer 18 may be formed before the magnetic layer forming step (S104).

In the present exemplary embodiment, the underlayer paint, the magnetic layer paint, and the back-coat layer paint are applied by means of a nozzle application method. However, each of the paints may be applied by means of other application methods such as a reverse roll coating method, a gravure roll coating method, a knife coater method, a doctor blade method, a kiss-coat method, a color-coat method, or a slide bead coating method.

Moreover, in the present exemplary embodiment, only the calendering step (S108) is carried out between the back-coat layer forming step (S106) and the cutting step (S110). However, cross-linking treatment by heating or irradiation of electron rays or the like, burnishing treatment, blade treatment, or the like may be carried out between the back-coat layer forming step (S106) and the cutting step (S110) in accordance with need.

Furthermore, in the present exemplary embodiment, the calendering step (S108) is carried out only between the back-coat layer forming step (S106) and the cutting step (S110). However, the calendering step may be carried out a plurality of times. For example, the calendering step may also be carried out between the magnetic layer forming step (S104) and the back-coat layer forming step (S106). Furthermore, the calendering step may be carried out after each of the layers is formed.

Moreover, in the present exemplary embodiment, the plate-like inorganic pigment is mixed into the back-coat layer 18. However, the plate-like inorganic pigment may be mixed into the underlayer 14. Furthermore, an intermediate layer into which the plate-like inorganic pigment is mixed may be provided between the underlayer 14 and the magnetic layer 16 or between the support 12 and the underlayer 14. Also in these cases, an intermediate product having a plate-like inorganic pigment-containing layer such as the underlayer 14 or the intermediate layer is subjected to calendering between at least one pair of metal rolls to thereby suppressing the surface roughness of the plate-like inorganic pigment-containing layer. In this manner, a magnetic recording medium can be manufactured which has high recording density and which is less likely to cause problems of magnetic tape, such as inappropriate contact with a head, unstable running, and damage on the surface of the tape.

### WORKING EXAMPLES

Four types of magnetic tapes were manufactured in accordance with the method of the above-described exemplary embodiment. Each of the magnetic tapes was wound on a reel, and the reel was mounted within a cartridge. Thus, four types of magnetic recording media were manufactured. In the four types of the magnetic tapes, the configurations of the back-coat layer 18 are different, i.e., the plate diameters of plate-like iron oxide (plate-like inorganic pigment) contained in the back-coat layer 18 are different. The configurations other than this feature are the same.

First, four rolls of the support 12 were provided, and the underlayer 14 was formed thereon. Specifically, the materials listed below were kneaded in a kneader.

Non-magnetic powder: 80.0 parts by weight of needle-like α-Fe₂O₃ (average major axis length: 0.1 μm, crystalline diameter: 12 nm)

Non-magnetic powder: 20.0 parts by weight of carbon black (product of Mitsubishi Chemical Corporation, product name: #950B, average particle size: 17 nm, BET specific surface area: 250 m²/g, DBP oil absorption value: 70 ml/100 g, pH: 8)

Electron beam curable binder: 12.0 parts by weight of electron beam curable vinyl chloride resin (product of Toyobo Co., Ltd., product name: TB-0246, (solid content) a copolymer of vinyl chloride and epoxy-containing monomer, average polymerization degree: 310, S content from the use of potassium persulfate: 0.6% (weight %), prepared by acrylic modification of MR110 (product of Zeon Corporation) using 2-isocyanate ethyl methacrylate (MOI), acrylic content: 6 moles/1 mole)

Electron beam curable binder: 10.0 parts by weight of electron beam curable polyurethane resin (product of Toyobo Co., Ltd., product name: TB-0216, (solid content) hydroxy containing acrylic compound-phosphonic acid group containing phosphorus compound-hydroxy containing polyester polyol, average molecular weight: 13,000, P content: 0.2% (weight %), acrylic content: 8 moles/1 mole)

Dispersant: 1.0 part by weight of phosphoric ester (product of Toho Chemical Industry Co., Ltd., product name: RE-610)

Abrasive: 5.0 parts by weight of α-alumina (product of Sumitomo Chemical CO., Ltd., product name: HIT60A, average particle size: 0.18 μm)

The solid concentration NV (non-volatile) was 33 (weight %).

The mixture was then subjected to dispersion by means of a horizontal pin mill filled with zirconia beads having a particle diameter of 0.8 mm at a filling ratio of 80% (void ratio: 50 vol %). Subsequently, the lubricant materials listed below were further added.

Lubricant: 1.0 part by weight of fatty acid (product of NOF Corporation, product name: NAA180)

Lubricant: 0.5 parts by weight of fatty amide (product of Kao Corporation, product name: Fatty amide S)

Lubricant: 1.5 parts by weight of fatty ester (product of is Nikko Chemicals Co., Ltd., product name: NIKKOL BS)

The mixture was diluted with solvents (the ratio of solvents: MEK/toluene/cyclohexanon=2/2/1 (weight ratio)) such that NV (solid concentration)=25% (weight %) and then was subjected to dispersion.

Subsequently, the thus obtained paint was filtrated through a filter having an absolute filtration rating of 3.0 μm.

Furthermore, 0.2 parts by weight of a heat curing agent (Colonate L, product of Nippon Polyurethane Industry Co., Ltd.) was added to and mixed with the above mixture, and then the thus obtained mixture was filtrated through a filter having an absolute filtration rating of 1.0 μm to prepare an underlayer paint used in Working Examples.

Subsequently, the underlayer paint was applied to each of the supports 12 made of polyethylene naphthalate and having a thickness of approximately 6.2 μm by means of a nozzle application method, and the applied underlayer paint was dried. Furthermore, each of the supports 12 was subjected to calendering by means of a calendering apparatus having a combination of a plastic roll and a metal roll (the number of nips: 4, working temperature: 100° C., linear pressure: 3.5×10⁵N/m, speed: 150 m/min). Then, an electron beam was projected at a dose of 4.0 Mrad to thereby form the underlayer 14.

Next, the magnetic layer 16 was formed on the underlayer 14. Specifically, the materials listed below were kneaded in a kneader.

Magnetic powder: 100.0 parts by weight of Fe-based needle-like ferromagnetic powder (Fe/Co/Al/Y=100/20/3/10 (atomic ratio), Hc: 180 kA/m, σs: 135 Am²/kg, BET specific surface area: 55 m²/g, average major axis length: 0.09 μm)

Binder: 10.0 parts by weight of vinyl chloride copolymer (product of Zeon Corporation, product name: MR110)

Binder: 6.0 parts by weight of polyester polyurethane (product of Toyobo Co., Ltd., product name: UR8300)

Dispersant: 3.0 parts by weight of phosphoric ester (product of Toho Chemical Industry Co., Ltd., product name: RE610)

Abrasive: 10.0 parts by weight of α-alumina (product of Sumitomo Chemical CO., Ltd., product name: HIT60A, average particle size: 0.18 μm)

Ratio of solvents: MEK/toluene/cyclohexanon=4/4/2 (weight ratio)

Here, the solid concentration NV was 30 weight %. Subsequently, the mixture was subjected to preliminary dispersion by means of a horizontal pin mill filled with zirconia beads having a particle diameter of 0.8 mm at a filling ratio of 80% (void ratio: 50 vol %). Subsequently, the mixture was diluted with solvents (the ratio of solvents: MEK/toluene/cyclohexanon=22.5/22.5/55 (weight ratio)) such that NV (solid concentration)=15% (weight %) and then was subjected to final dispersion.

Furthermore, 10.0 parts by weight of a heat curing agent (Colonate L, product of Nippon Polyurethane Industry Co., Ltd.) was added to and mixed with the above mixture, and then the thus obtained mixture was filtrated through a filter having an absolute filtration rating of 1.0 μm to prepare a magnetic layer paint.

The magnetic layer paint was ejected from a nozzle and was applied to the underlayer 14 formed on each of the supports 12.

Subsequently, the magnetic layer paint was applied while alignment treatment was performed. Then the solvent components of the magnetic layer paint were volatilized to dry the magnetic layer paint. Furthermore, calendering was performed by use of a plastic roll and a metal roll to form the magnetic layer 16.

Next, the back-coat layer 18 was formed on a surface of each of the support 12 which surface is opposite to the other one having the magnetic layer 16 formed thereon. Specifically, the materials listed below were sufficiently kneaded in a kneader.

70.0 parts by weight of plate-like iron oxide (plate-like inorganic pigment) (average plate diameter: 0.15 μm, 0.20 μm, 0.30 μm, or 0.50 μm, plate diameter to thickness ratio: 10)

30.0 parts by weight of carbon black (product of Cabot Corporation, product name: BP-130, average particle diameter: 75 nm, DBP oil absorption value: 69 ml/100 g, BET specific surface area: 25 m²/g)

18.0 parts by weight of nitrocellulose (product of Asahi Kasei Corporation, product name: BTH1/2)

7.0 parts by weight of polyurethane resin (product of Toyobo Co., Ltd., product name: UR-8300, containing sodium sulfonate)

5.0 parts by weight of carboxylic acid amine salt (product of Kusumoto Chemicals, Ltd., product name: DA-7300)

200.0 parts by weight of methyl ethyl ketone

200.0 parts by weight of toluene

170.0 parts by weight of cyclohexanone

Subsequently, the mixture was subjected to dispersion by means of a horizontal pin mill filled with zirconia beads having a particle diameter of 0.8 mm at a filling ratio of 80% (void ratio: 50 vol %). Subsequently, the materials listed below were added, and the mixture was subjected to further dispersion by means of the abovementioned horizontal pin mill.

350.0 parts by weight of methyl ethyl ketone

350.0 parts by weight of toluene

100.0 parts by weight of cyclohexanone

Here, the average plate diameter of the plate-like iron oxide is the average value of the maximum diameters of 100 randomly selected particles. The maximum diameter of the particles was measured by means of a TEM (Transmission Electron Microscope).

As described above, four types of the back-coat layer paints having different plate diameters of the plate-like iron oxide were produced.

Each of these back-coat layer paints was ejected from the nozzle 20 and was applied to the surface of one of the supports 12 which surface is opposite to the other one having the magnetic layer 16 formed thereon. The coating was then dried. Furthermore, calendering was carried out by means of pairs (four pairs in Working Examples) of the metal rolls 22A and 22B (the number of nips: 4, working temperature: 100° C., linear pressure: 2.9×10⁵ N/m, speed: 100 m/min), thereby forming the back-coat layer 18 having a thickness of approximately 0.7 μm. Here, the metal rolls 22A and 22B are rolls of SUJ (high carbon chromium bearing steel) with a surface subjected to hard chromium plating and having a diameter of 300 mm.

As described above, the underlayer 14, the magnetic layer 16, and the back-coat layer 18 were formed over each of the supports 12, thereby producing intermediate products 10. Each of the intermediate products 10 was wound on a roll and was allowed to stand at room temperature for 24 hours. Then, each of the intermediate products 10 was held in a temperature environment of 60° C. for about 48 hours for heat curing and was then cut to a width of 12.65 mm (½ inches) to produce a magnetic tape.

Each of the thus obtained four types of the magnetic tapes was wound on a reel (not shown), and each of the reels was mounted within a cartridge (not shown), thereby manufacturing four types of magnetic recording media.

The magnetic tape of each of the magnetic recording media was measured for the arithmetic average surface roughness Ra of the back-coat layer 18. Specifically, the arithmetic average surface roughness Ra was measured by means of a TARYSTEP system (product of Taylor Hobson K.K.) and according to JIS B 0601-1994. The conditions of the measurement apparatus were set as follows.

Filter condition: 0.3 to 9.0 Hz

Stylus: 0.1×2.5 μm stylus

Stylus pressure: 2 mg

Measurement speed: 0.03 mm/sec

Length of measurement portion: 500 μm

The measurement results of the arithmetic average surface roughness Ra are shown in Table 1.

Furthermore, the error rate of the magnetic tape of each of these magnetic recording media was measured. Specifically, using a drive device Ultium460e (product of Hewlett-Packard Development Company, L.P.) and SCSI control software, approximately 8 Gbits of random data were recorded from a data area starting position of the magnetic tape and then were reproduced. At this time, the number of correctable C1 errors extracted by the SCSI control software was converted to bits, which were used as the error rate. Specifically, the error rate can be represented by the following formula:

Error rate=log₁₀(the number of C1 error bits/the total number of written bits).

The measurement results of the error rate are shown in Table 1.

Moreover, the durability of the magnetic tape of each of the magnetic recording media was measured. Specifically, the magnetic tape of each of the magnetic recording media was repeatedly run in an environment of 40 to 80° C. for 48 hours using a drive device DLTIV7000 (product of Quantum Corp.). The magnetic tape was run at a running speed of approximately 2.5 m/min. Subsequently, the surface of the magnetic layer 16 of the magnetic tape of each of the magnetic recording media was observed under an optical microscope to determine the degree of damage on the surface of the magnetic layer 16. More specifically, a randomly selected area of 12.65 mm width and 300 mm length on the surface of the magnetic layer 16 of the magnetic tape which had been repeatedly run for 48 hours was observed under an optical microscope at 100× magnification to determine the presence or absence of flaws on the surface of the magnetic layer 16. In addition to this, a magnetic head was removed from the drive device, and the surface of the magnetic head was observed under an optical microscope at 50× magnification to determine the presence or absence of adhering materials which had flaked off the magnetic layer 16 and had adhered to the magnetic head. The observation results are shown in Table 1.

TABLE 1

| | Average plate | | Surface | | |
|---|---|---|---|---|---|
| | diameter of | | roughness Ra | | |
| | plate-like | Linear | of back-coat | | Durability |
| | iron oxide | pressure | layer | | (Damage of |
| | μm | N/m | nm | Error rate | magnetic layer) |
| Working | 0.50 | 2.9 × 10⁵ | 13.8 | −7.0 | Δ |
| Examples | 0.30 | | 10.0 | −7.6 | ◯ |
| | 0.20 | | 9.4 | −7.8 | ◯ |
| | 0.15 | | 9.1 | −7.8 | ◯ |
| Comparative | 0.50 | | 16.8 | −6.5 | X |
| Examples | 0.30 | | 15.2 | −6.8 | X |
| | 0.20 | | 14.7 | −6.9 | X |
| | 0.15 | | 14.1 | −6.8 | X |
| | 0.15 | 3.4 × 10⁵ | 13.5 | −7.0 | X |

A circle in Table 1 represents that no flaws are found on the surface of the magnetic layer 16 and no adhering materials are found on the magnetic head. A triangle in Table 1 represents that flaws are found on the surface of the magnetic layer 16 but no adhering materials are found on the magnetic head. Therefore, the triangle represents that there are no practical problems. Furthermore, a cross (Comparative Examples) in Table 1 represents that flaws are found on the surface of the magnetic layer 16 and adhering materials are found on the magnetic head. Therefore, the cross represents that there are practical problems.

### COMPARATIVE EXAMPLES

In contrast to Working Examples above, calendering was carried out after the formation of the back-coat layer 18 using pairs (four pairs in Comparative Examples) of a metal roll and an elastic roll in place of pairs (four pairs in Working Examples above) of two metal rolls. Other conditions were the same as those in Working Examples, and four types of magnetic recording media were produced. The material for the elastic roll was epoxy resin. The shape of the elastic roll was the same as that of the metal rolls 22A and 22B in Working Examples.

In addition to these, one more magnetic recording medium was manufactured which was provided with a magnetic tape having the back-coat layer 18 containing the abovementioned plate-like iron oxide having an average plate diameter of 0.15 μm. Specifically, in this magnetic tape, the linear pressure between the pairs of the metal roll and the elastic roll during calendering was set to 3.4×10⁵ N/m which is larger than that in Working Examples.

For the magnetic tape of each of these five types of the magnetic recording media of Comparative Examples, the surface roughness Ra of the surface of the back-coat layer 18, error rate, and durability were determined as in Examples. The results are shown in Table 1.

As can be seen in Table 1, there is a tendency in both Working Examples and Comparative Examples that the larger the average plate diameter of the plate-like iron oxide contained in the back-coat layer 18 is, the larger the arithmetic average surface roughness Ra of the surface of the back-coat layer 18 becomes.

On the other hand, it was found that the arithmetic average surface roughness Ra of the surface of the back-coat layer 18 in Working Examples is smaller than that in Comparative Examples when the average plate diameters of the plate-like iron oxide contained in the back-coat layer 18 are the same. This may be because of the following reason. That is, the calendering of the back-coat layer 18 was carried out using the pairs of the metal roll and elastic roll in Comparative Examples, but the calendering of the back-coat layer 18 was carried out using the pairs of the two metal rolls 22A and 22B in Working Examples.

Furthermore, in each of the magnetic tapes of Comparative Examples, damage on the surface of the magnetic layer 16 was found to the extent that practical problems arise. However, in each of the magnetic tapes of Working Examples, damage which may cause practical problems was not found on the surface of the magnetic layer 16. This may be because the arithmetic average surface roughness Ra of the surface of the back-coat layer 18 which is to be rubbed with the magnetic layer 16 is smaller in Working Examples than in Comparative Examples as described above.

Therefore, the damage on the magnetic layer 16 was more suppressed in Working Examples than in Comparative Examples, and thus it was found that the durability is higher in Working Examples. In particular, when the average plate diameter of the plate-like iron oxide contained in the back-coat layer 18 is 0.15 to 0.30 μm, the surface roughness of the back-coat layer 18 is suppressed to particularly smaller values in Working Examples than in Comparative Examples, and thus the effect on suppressing the damage on the magnetic layer 16 is significant.

Next, a sample of Working Examples which contains the plate-like iron oxide having a plate diameter of 0.50 μm is compared with two samples of Comparative Examples which contain the plate-like iron oxide having a plate diameter of 0.15 μm. In this case, the arithmetic average surface roughnesses of the surfaces of the back-coat layers 18 of these samples are almost the same. However, the degree of damage on the magnetic layer 16 is smaller in the sample of Working Example than in the samples of Comparative Examples. This may be because of the following reason. As described above, the calendering of the back-coat layer 18 of the above sample of Working Example was carried out using the pairs of two metal rolls 22A and 22B. Conversely, the calendering of the back-coat layers 18 of the above samples of Comparative Examples was carried out using the pairs of the metal roll and the elastic roll. Therefore, although the arithmetic average surface roughnesses Ra of the surfaces of the back-coat layers 18 are almost the same, it is conceivable that the projections on the surface of the back-coat layer 18 are microscopically sharper in the samples of Comparative Examples than in the sample of Working Example.

Moreover, there is a tendency in both Working Examples and Comparative Examples that the larger the average plate diameter of the plate-like iron oxide contained in the back-coat layer 18 is, the larger the error rate becomes, as in the arithmetic average surface roughness Ra of the surface of the back-coat layer 18. However, when the average plate diameters of the plate-like iron oxide contained in the back-coat layer 18 are the same, the error rate is smaller in Working Examples than in Comparative Examples. This may be because of the following reason. That is, the damage of the magnetic layer 16 is less in Working Examples than in Comparative Examples, and the arithmetic average surface roughness Ra of the surface of the back-coat layer 18 is smaller in Working Examples than in Comparative Examples (when the average plate diameters of the plate-like iron oxide are the same). Therefore, in each of Working Examples, the surface roughness of the magnetic layer 16 is suppressed to small values, and thus the contact between the magnetic tape and the head is favorable, thereby providing the stable running of the magnetic tape to make the error rate smaller.

It is empirically known that data recorded on a magnetic tape can be satisfactorily reproduced provided that the error rate is −7.0 or less. In one of the magnetic tapes of the five types of the magnetic recording media of Comparative Examples, the plate diameter of the plate-like iron oxide contained in the back-coat layer 18 was 0.15 μm, and the calendering of the back-coat layer 18 was carried out at a linear pressure of 3.4×10⁵ N/m. The error rate of this magnetic tape was −7.0. However, in the magnetic tapes of the other four types of the magnetic recording media, the error rate was larger than −7.0. On the other hand, in each of the magnetic tapes of the four types of the magnetic recording media of Working Examples, the error rate was −7.0 or less. Accordingly, in the magnetic tapes of Working Examples, data recorded on the magnetic tape can be satisfactorily reproduced.

The present invention is applicable to the manufacturing of a magnetic recording medium provided with a magnetic tape.

What is claimed is:

1. A method for manufacturing a magnetic recording medium, comprising:
a plate-like inorganic pigment-containing layer forming step of forming a plate-like inorganic pigment-containing layer containing plate-like inorganic pigment over a non-magnetic support to produce an intermediate product having the support and the plate-like inorganic pigment-containing layer; and
a calendaring step of calendering the intermediate product between at least one pair of metal rolls, wherein the steps are carried out sequentially in this order.

2. The method for manufacturing a magnetic recording medium according to claim 1, wherein
the plate-like inorganic pigment-containing layer contains plate-like iron oxide serving as the plate-like inorganic pigment.

3. The method for manufacturing a magnetic recording medium according to claim 1, wherein
in the plate-like inorganic pigment-containing layer forming step, a back-coat layer is formed to serve as the plate-like inorganic pigment-containing layer.

4. The method for manufacturing a magnetic recording medium according to claim 2, wherein
in the plate-like inorganic pigment-containing layer forming step, a back-coat layer is formed to serve as the plate-like inorganic pigment-containing layer.

5. The method for manufacturing a magnetic recording medium according to claim 3, wherein
the back-coat layer contains the plate-like inorganic pigment and carbon.

6. The method for manufacturing a magnetic recording medium according to claim 4, wherein
the back-coat layer contains the plate-like inorganic pigment and carbon.
